(19) United States
(12) Patent Application Publication
(10) Pub. No.: US 2019/0144249 A1
(43) Pub. Date: May 16, 2019

(54) FULLY AUTONOMOUS VEHICLE LIFT

(71) Applicant: Ford Global Technologies, LLC, Dearborn, MI (US)

(72) Inventor: Greg Bartos, Little Elm, TX (US)

(73) Assignee: Ford Global Technologies, LLC, Dearborn, MI (US)

(21) Appl. No.: 15/812,031

(22) Filed: Nov. 14, 2017

(51) Int. Cl. B66F 7/28; B66F 7/06; B66F 3/46

(52) U.S. Cl. CPC B66F 7/28; B66F 2700/123; B66F 3/46; B66F 7/065

(57) ABSTRACT

The disclosed inventive concept provides an autonomous vehicle lift system in which the lift arms are automatically placed into their correct positions prior to the vehicle being lifted for servicing. The system includes a pair of spaced apart vertical posts and a wheel locator. Each post is fitted with a vertically movable lift arm assembly. Each lift arm assembly includes a pair of independently operating lift arms and drive systems for both rotating the arm into position and for extending the arm. At the end of each lift arm is a lift pad. Each lift pad may include a scissors system for lifting and lowering the pad relative to the associated arm. An operator's station is provided for inputting vehicle information. Once the information is entered, the autonomous lift system is initiated. The lift arms automatically move into their correct predetermined positions and the vehicle is ready to be lifted.

### TECHNICAL FIELD

The disclosed inventive concept relates to a lift system for a vehicle. More particularly, the disclosed inventive concept relates to a lift system for a vehicle that operates autonomously to locate lift pads under predetermined lift points of a given vehicle. Once the vehicle is placed in position relative to the lift, the operator needs only to input vehicle identification information and initiate the drive system. After the system is initiated, the lift arms and the lift pads are moved autonomously into position and the lifting operation commences.

### BACKGROUND OF THE INVENTION

Vehicles ordinarily require a variety of services during their operating lifetimes. Some services, such as oil changes, can be performed with the vehicle on a floor of a shop in which a pit is formed in the floor. The oil changers work from the sub-surface pit and thus no vertical movement of the vehicle is necessary. Other under-hood services can also be performed while the vehicle is resting on a shop floor, such as air filter changes and removal and replacement of spark plugs.

However, frequently the vehicle must be lifted off of the shop floor to allow technicians access to the vehicle's underside. In such cases, the vehicle is driven into a service bay with a vehicle lift designed for this purpose. The vehicle lift typically includes a pair of spaced-apart and opposed posts, commonly referred to as a two-post lift. A two-post lift is comprised of four (4) moveable lift arms with vertically adjustable lift pads on the end of the arm. The lift arms on a two-post lift adjust radially to “swing” underneath the vehicle. The two-post lift arm also extends or retracts in an outward and inward fashion to be placed in the appropriate area for proper lifting of the vehicle. Lastly, the lift pad that is on the end of the lift arm must be adjusted to the correct height so the vehicle's lifting point is properly engaged by the two-post lift and there is no interference between the lift arm and the undercarriage of the vehicle.

One of the crucial steps to lift a vehicle off the ground using the industry standard two-post lift includes properly placing the lift arms. The lift arms must be placed accurately to avoid damage to the undercarriage or body panels of the vehicle. Properly placing the lift arms also guarantees vehicle stability while it is off the ground. Vehicle stability while it is off the ground is a critical requirement for the safety of the service technicians as vehicle instability can lead to a vehicle falling off a two-post lift.

Manual placing the lift arms requires knowledge of the proper lift point location on the vehicle. Placement in this manner requires several adjustments to the lift arm and pad. In the automotive industry, it is common for novice technicians to be tasked with entry-level work that includes a vehicle's routine oil change, tire rotation and inspection which require lifting a vehicle. It is possible for any level of experienced technician to improperly locate the lift arm. It is more common for novice technicians to improperly place lift arms which results in a safety concern and the possibility of vehicle damage.

While manually placing the lift arms, the service technician may also sustain immediate or long lasting injuries. While the lift arms slide outward/inward it is possible for a service technician to pinch a finger in the moving arm or lift pad. Manually placing the lift arms requires a technician to get on their hands and knees to properly locate the lift point on the vehicle. Over years of performing vehicle maintenance that requires lifting a vehicle off the ground, bending over and getting on the hands and knees on the concrete shop floor can result in injuries. It is common for service technicians to have a cushion for their knees to prevent injury while placing lift arms.

Adding to the inherent difficulties in arranging lift arms under a vehicle, there is a substantial demand today to provide a customer with a “quick auto service” of some type. Many “quick change” oil services attract customers by offering the convenience of a “no-appointment necessary service” in the most time-efficient manner possible. Today's lift manufacturers and service centers equip their lifts with larger drive motors, thereby decreasing the amount of time required to raise and lower the vehicle, which is marketed to reduce the total length of service. While adding a larger drive motor decreases the amount of time it takes to raise and lower a vehicle, this approach does not address the time consuming process needed to place lift arms.

Accordingly, known approaches to lifting a vehicle for service do not produce satisfactory results. The current approach to lifting a vehicle can present a safety risk to servicing technicians, result in vehicle damage, and include a time consuming process to place lift arms. As vehicle technology increases, so must the manner in which we service these vehicles.

### SUMMARY OF THE INVENTION

The disclosed inventive concept provides an autonomous vehicle lift system in which the lift arms are automatically placed into their correct positions prior to the vehicle being lifted off of the shop floor for servicing. The autonomous vehicle lift system of the disclosed inventive concept can be adapted for use with a lift having fixed above-ground lift arm posts or retractable in-ground systems. The autonomous vehicle lift system disclosed provides an avenue for reducing the amount of time it takes to rack a vehicle, or to place it on the vehicle lift and lift the vehicle into the air. This can be done while virtually eliminating any risk of injury.

The autonomous vehicle lift system of the disclosed inventive concept includes a pair of spaced apart vertical posts. A vehicle wheel locator is preferably provided on the shop floor to assure that the vehicle is parked in its correct position prior to initiating operation of the autonomous lift. Each post is fitted with a vertically movable lift arm assembly. Each lift arm assembly includes a pair of independently operating lift arms and drive systems for both rotating the arm into position and for extending the arm to its preferred length. The lift arms may be multi-segment and telescoping. At the end of each lift arm is a lift pad that is preferably though not absolutely of the low-profile variety. The lift pads may each include a scissors system for lifting and lowering the pad relative to the associated lift arm. One or more position-locating sensors may be fitted to either or both of the lift pad and the lift arm.

An operator's station is provided that allows the operator to input identifying information about the vehicle. Such information may be the Vehicle Identification Number (VIN) or may include descriptive information such as the vehicle brand, type, wheelbase and year. A scanner is preferably provided to allow the technician to scan the VIN. Alternatively, the vehicle information may be manually entered using a control board. An interface is provided between the operator's station and the lifting assemblies.

To lift a vehicle using the autonomous vehicle lift system of the disclosed inventive concept, the vehicle to be lifted is moved into position relative to the lift system. At this step one or both of the vehicle's front wheels are positioned onto a front wheel locator. The operator then enters the vehicle's identification information into an operator's station either manually using a keyboard or using a scanner suited for this purpose. Thereafter, once the identification information is entered, the operator uses the operator's station to initiate the autonomous vehicle lifting protocol. Once initiated, no further input by the operator is necessary until after the service is performed to the vehicle and the lift can be moved to its lowered position.

The lift arms are automatically pivoted into position and are extended until the lift pads are positioned beneath the pre-programmed preferred vehicle lift points. The lift pads are then raised until they are in contact with the lift points on the vehicle. Finally, the lift arms raise the vehicle to a pre-selected height to thereby allow the desired vehicle service to be performed. The vehicle remains lifted until the required service is completed and the operator lowers the vehicle, after which the lift arms are returned to their pre-lifting positions in preparation for the next lifting operation.

The autonomous vehicle lift system of the disclosed inventive concept efficiently substitutes twelve steps required by known lift systems for a single easy and safe step. Instead of the operator having to manually pivot, extend and retract each of the four lift arms and then adjust each lift pad, the only requirement is that the operator entering the vehicle identification information and thereafter the placements of the arms and pads are automatically performed.

The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 is a perspective view of the lift system according to one embodiment of the disclosed inventive concept;

FIG. 2 is a perspective view of the lift system according to another embodiment of the disclosed inventive concept;

FIG. 3 is a perspective view of a lift assembly according to an embodiment of the disclosed inventive concept;

FIG. 4 is a top view of a lift arm assembly according to another embodiment of the disclosed inventive concept;

FIG. 5 is a top view of a lift arm assembly according to an additional embodiment of the disclosed inventive concept;

FIG. 6 is an end view of the lift arm assembly illustrated in FIG. 5;

FIG. 7 is a side view of an embodiment of a lift arm for use in the lift system of the disclosed inventive concept;

FIG. 8 is a side view of another embodiment of a lift arm for use in the lift system of the disclosed inventive concept;

FIG. 9 is a side view of a lifting pad fitted to the end of a lift arm for use in the disclosed inventive concept;

FIG. 10 is an end view of the lift arm having the lifting pad of FIG. 9;

FIG. 11 is a perspective view of the lift arm and lifting pad of FIG. 9;

FIG. 12 is a perspective view of a pair of lift ramps with each lift ramp having a plurality of lift pads; and

FIG. 13 is a perspective view of a pair of side-by-side scissors lifts with each scissors lift having a lift ramp fixed to the top thereof.

### DETAILED DESCRIPTION OF THE PREFERRED EMBODIMENTS

In the following figures, the same reference numerals will be used to refer to the same components. In the following description, various operating parameters and components are described for different constructed embodiments. These specific parameters and components are included as examples and are not meant to be limiting.

The accompanying figures and the associated description illustrate the autonomous vehicle lift system of the disclosed inventive concept. Alternative versions of the vehicle lift system are illustrated as are alternative version of the lift arms. It is to be understood that the illustrated embodiments are suggestive as the shapes of, for example, the vertical posts and the lift arms, may be adopted without deviating from the spirit or scope of the disclosed inventive concept.

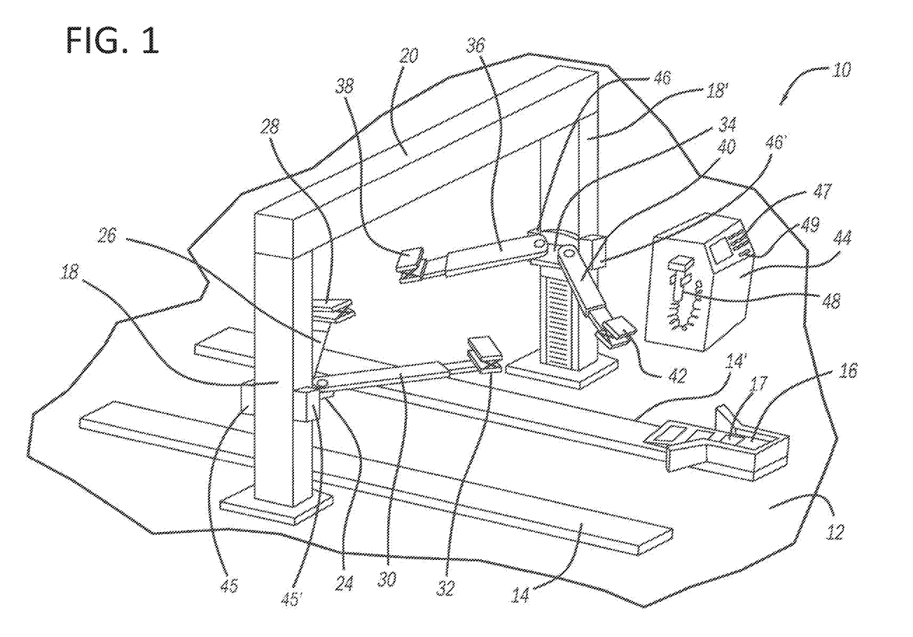

Referring to FIG. 1, a perspective view of an embodiment of the autonomous vehicle lift system of the disclosed concept is shown. The lift system, generally illustrated as 10, may be used in any of a variety of settings including, without limitation, a vehicle garage. The illustrated autonomous lift system 10 is adapted for attachment to an already-existing garage or shop floor 12.

The autonomous vehicle lift system 10 includes a set of spaced apart wheel guides 14 and 14′ for guiding the vehicle to be lifted (not shown). The guides 14 and 14′ may be slightly raised off of the floor 12 or may be flush with the floor 12. By providing a definite position system for the vehicle, proper alignment of the lift pads can be undertaken. On one or both of the wheel guides 14 and 14′ a wheel locator is provided to achieve precise positioning of the vehicle. One such wheel locator 16 is illustrated. The wheel locator 16 is a metal tire guide that includes one or more pressure pads 17 to determine the wheel location when the vehicle is positioned on the guides 14 and 14′.

The autonomous vehicle lift system 10 further includes a pair of spaced apart vertical posts 18 and 18′. The vertical posts 18 and 18′ are fixed to the floor 12. A horizontal beam 20 connects one vertical post 18 to the other vertical post 18′ to provide maximum structural integrity.

Movably attached to vertical post 18 is a lift arm assembly that includes a vertically movable lift arm support 24. The vertically movable lift arm support 24 may be vertically lifted up or down by any of several known arrangements, such as by a hydraulic system or a mechanical screw.

Pivotably attached to the vertically movable lift arm support 24 is a pivotable lift arm 26. Attached to one end of the pivotable lift arm 26 is a lift pad 28. Also pivotably attached to the vertically movable lift arm support 24 is a pivotable lift arm 30. Attached to one end of the pivotable lift arm 30 is a lift pad 32. The lift pads 28 and 32 may be fitted with alignment sensors to assist in proper alignment relative to the lift points defined on the underside of the vehicle. The lift pads 28 and 32 may be of the low-profile type, thereby allowing easy movement beneath the vehicle.

Movably attached to vertical post 18′ is a lift arm assembly that includes a vertically movable lift arm support 34. The vertically movable lift arm support 34 may be vertically lifted up or down by any of several known arrangements, such as by a hydraulic system or a mechanical screw. The vertical post of the vertical posts 18 and 18′ are fitted with a motor pack (not illustrated) to vertically drive the lift arm supports 24 and 34 respectively.

Pivotably attached to the vertically movable lift arm support 34 is a pivotable lift arm 36. Attached to one end of the pivotable lift arm 36 is a lift pad 38. Also pivotably attached to the vertically movable lift arm support 34 is a pivotable lift arm 40. Attached to one end of the pivotable lift arm 40 is a lift pad 42.

The positions of the pivotable lift arms 26, 30, 36, and 40 relative to the vertically movable lift arm support are adjusted by motors integrally associated with the vertical posts 18 and 18′. A first pair of lift arm motors 45 and 45′ is associated with the vertical post 18 for selectively rotating the pivotable lift arms 26 and 30 respectively. A second pair of lift arm motors 46 and 46′ is associated with the vertical post 18′ for selectively rotating the pivotable lift arms 36 and 40 respectively. The lift arm motors 45, 45′, 46 and 46′ may be any of several arrangements, including but not limited to a hydraulic system or a mechanical screw system.

The autonomous vehicle lift system 10 of the disclosed inventive concept further includes an arrangement by which the identification of the vehicle can be entered. As illustrated, a preferred identification input arrangement is an operator's station 47. The operator's station 47 includes a control board 46 and a vehicle identification input system such as a scanner 48. The control board 46 includes a lift “UP” button and a lift “DOWN” button. The vehicle identifying information can be, for example, the Vehicle Identification Number (VIN) or the vehicle year, type and model. The vehicle identifying information can be entered either using the keyboard of the control board 46 or using the scanner 48. An interface is provided between the operator's station 47 and the lifting assemblies. The operator's station 47 further includes an up/down button 49 to complete the lift of the vehicle. While the system of the disclosed inventive concept automatically moves the lift pads 28, 32, 38 and 42 into position once the operator initiates the system as will be explained below, it is necessary for the operator to hold the up/down button 49 to selectively raise or lower the vehicle to maximize safe operation. For example, if a co-worker walks underneath the vehicle the vehicle being lifted appears not to be stable or if some other urgent situation arises, the operator can manipulate the up/down button 49 as needed.

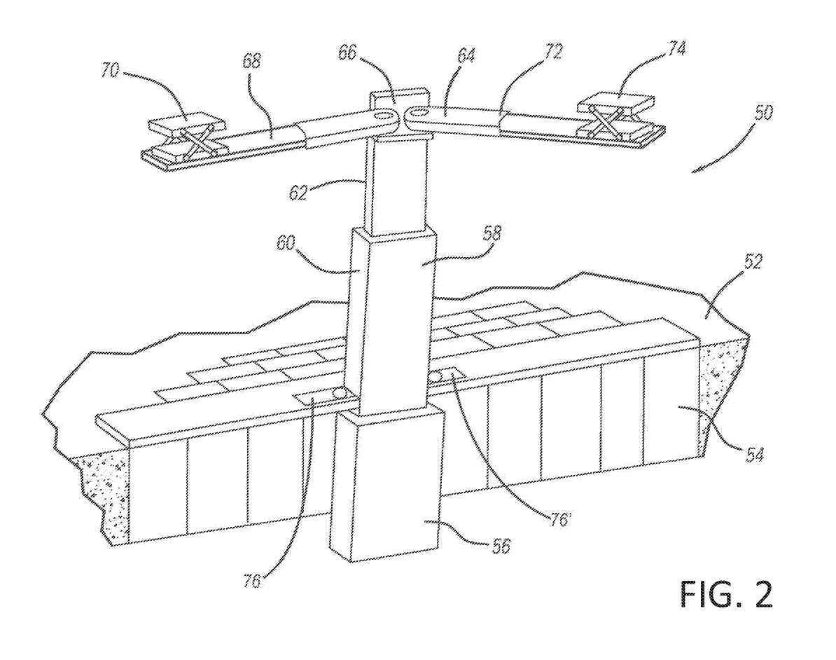

Referring to FIG. 2, a perspective view of another embodiment of the autonomous vehicle lift system of the disclosed concept is shown. The lift system, generally illustrated as 50, may also be used in any of a variety of settings including, without limitation, a vehicle garage. The illustrated autonomous vehicle lift system 50 is a dedicated system that is specifically intended for use with the autonomous vehicle lift arrangement of the disclosed concept. As such, the autonomous lift system 50 is incorporated into a floor 52. A sub-floor support arrangement, such as a sub-floor support 54, is integrally provided within the floor 52. A fixed vertical base 56 is integrated with the sub-floor support 54.

The fixed vertical base 56 is part of a telescoping lifting post 58. It is to be understood that while only one telescoping lifting post is illustrated, two such posts are provided in a spaced apart relationship. It is also to be understood that the wheel guides and wheel locator(s) of the embodiment of the disclosed inventive concept illustrated in FIG. 1 may also be included with the autonomous vehicle lift system 50 illustrated in FIG. 2.

The telescoping lifting post 58 of the autonomous vehicle lift system 50 includes a first vertically movable part 60 that rests entirely or substantially within the fixed vertical base 56 when the autonomous lift system 50 is in its lowered position. The telescoping lifting post arrangement 58 further includes a second vertically movable part 62 that also rests substantially within the first vertically movable part 60 when the autonomous lift system 50 is in its lowered position. A greater or lesser number of vertically movable parts may be adapted for use with the disclosed inventive concept.

The autonomous vehicle lift system 50 further includes a lift arm assembly 64. Both the telescoping lifting post 58 and its opposed lifting post not illustrated are fitted with a motor pack (not illustrated) to vertically drive the lift arm supports. The lift arm assembly 64 includes a vertically movable lift arm support 66 that is fixedly attached to the top of the second vertically movable part 62. Pivotably attached to the vertically movable lift arm support 66 is a pivotable and telescoping lift arm 68. Attached to one end of the pivotable lift arm 68 is a lift pad 70. Also pivotably attached to the vertically movable lift arm support 66 is a pivotable and telescoping lift arm 72. Attached to one end of the pivotable lift arm 72 is a lift pad 74. The lift pads 70 and 74 may be fitted with alignment sensors to assist in proper alignment relative to the lift points defined on the underside of the vehicle. The lift pads 70 and 74 may be of the low-profile type, thereby allowing easy movement beneath the vehicle.

As illustrated in FIG. 2, the lift arms 68 and 72 have been rotated to their desired positions for correctly and safely lifting the vehicle to be serviced (not shown). The correct positioning of the lift arms 68 and 72 is achieved prior to the vehicle being lifted. While the lift arm assembly is in its lowered, pre-lifted position (not shown), the lift arm 68 engages a lift arm motor 76 and the lift arm 72 engages a lift arm motor 76′ at which point the lift arm motor 76 rotates the lift arm 68 into position and the lift arm motor 76′ rotates the lift arm 72 into position. The lift arm motors 76 and 76′ are substantially embedded in the sub-floor support 54.

The positions of the pivotable lift arms 68 and 72 relative to the vertically movable lift arm support is adjusted by any of several arrangements, including but not limited to a hydraulic system or a mechanical screw system.

The autonomous vehicle lift system 50 of the disclosed inventive concept further includes an arrangement by which the identification of the vehicle can be entered the same as or similar to that set forth above with respect to the embodiment illustrated in FIG. 1.

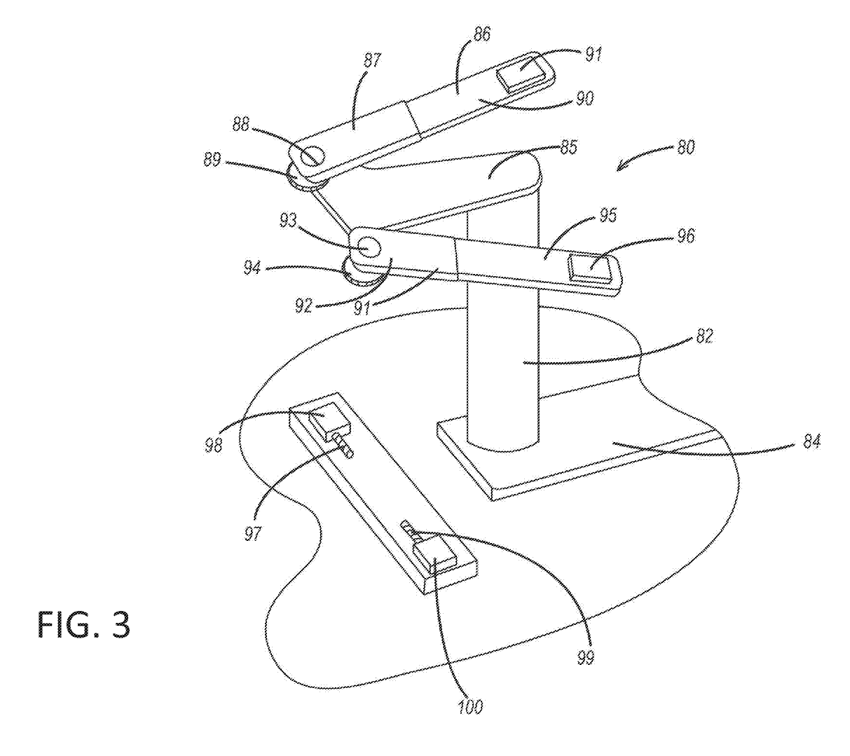

The lift arm assemblies illustrated with respect to the embodiments shown in FIGS. 1 and 2 are suggested and are not intended as being limiting. FIGS. 3 through 5 illustrate alternative embodiments of the lift arm assemblies of the disclosed inventive concept.

Referring to FIG. 3, a perspective view of a lift assembly according to one embodiment of the disclosed inventive concept is illustrated, generally shown as 80. The lift assembly 80 is an in-ground lift of the type illustrated in FIG. 2. The lift assembly 80 includes a vertically movable lift post 82 that may be selectively recessed in a floor support 84.

A vertically movable lift arm support 85 is fixed to the top of the lift post 82. Pivotably attached to the vertically movable lift arm support 85 is a first pivotable lift arm 86 that has a pivotable lift arm base 87. The pivotable lift arm base 87 is pivotably attached to the movable lift arm support 85 by a pivot 88. A driven gear 89 is attached to the pivotable lift arm base 87 A pivotable lift arm telescoping extension 90 is telescopingly attached to the pivotable lift arm base 87. A lifting pad 91 is attached to one end of the pivotable lift arm telescoping extension 90.

The lift assembly 80 further includes a second pivotable lift arm 91 that has a pivotable lift arm base 92. The pivotable lift arm base 92 is pivotably attached to the movable lift arm support 85 by a pivot 93. A driven gear 94 is attached to the pivotable lift arm base 92 A pivotable lift arm telescoping extension 95 is telescopingly attached to the pivotable lift arm base 92. A lifting pad 96 is attached to one end of the pivotable lift arm telescoping extension 95.

As illustrated in FIG. 3, the pivotable lift arms 86 and 91 have been rotated to their desired positions for correctly and safely lifting the vehicle to be serviced (not shown). The correct positioning of the lift arms 86 and 91 is achieved prior to the vehicle being lifted. While the lift assembly 80 is in its lowered, pre-lifted position (not shown), the driven gear 89 of the first pivotable lift arm 86 is engaged with a spiral driving screw gear 97 attached to a drive motor 98 while the driven gear 94 of the second pivotable lift arm 91 is engaged with a spiral driving screw gear 99 attached to a drive motor 100. When the driven gear 89 is engaged with the spiral driving screw gear 97 and the driven gear 94 is engaged with the spiral driving screw gear 99, the lift arms 86 and 91 are rotated into their correct lift positions between the vehicle to be lifted. The drive motors 98 and 100 may be operated electrically or hydraulically.

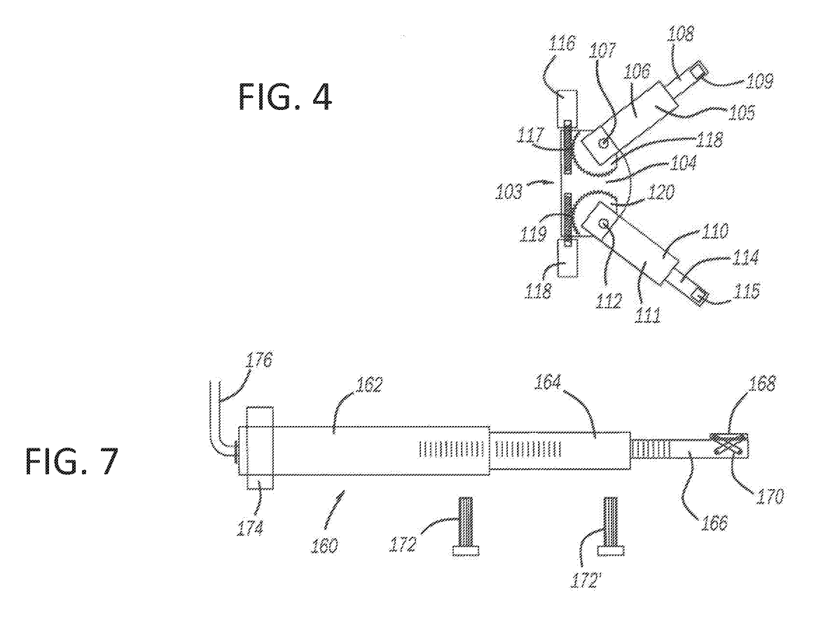

Referring to FIG. 4, a top view of a lift arm assembly according to another embodiment of the disclosed inventive concept is illustrated, generally shown as 103. The lift arm assembly 103 may be used with either fixed-post lifts of the type illustrated in FIG. 1 or with in-ground lifts of the type illustrated in FIG. 2.

The lift arm assembly 103 includes a vertically movable lift arm support 104. Pivotably attached to the vertically movable lift arm support 104 is a first pivotable lift arm 105 that has a pivotable lift arm base 106. The pivotable lift arm base 106 is pivotably attached to the movable lift arm support 104 by a pivot 107. A pivotable lift arm telescoping extension 108 is telescopingly attached to the pivotable lift arm base 106. A lifting pad 109 is attached to one end of the pivotable lift arm telescoping extension 108.

The lift arm assembly 103 further includes a second pivotable lift arm 110 that is pivotably attached to the vertically movable lift arm support 104. The pivotable lift arm 110 has a pivotable lift arm base 111. The pivotable lift arm base 111 is pivotably attached to the vertically movable lift arm support 104 by a pivot 112. A pivotable lift arm telescoping extension 114 is telescopingly attached to the pivotable lift arm base 111. A lifting pad 115 is attached to one end of the pivotable lift arm telescoping extension 114.

The positions of the pivotable lift arms 105 and 110 relative to the vertically movable lift arm support 104 is adjusted by any of several arrangements, including but not limited to a hydraulic system or a mechanical screw system. One such arrangement, a geared arrangement, is illustrated in FIG. 4. As shown, a two-direction lift arm drive motor 116 is fixed to the vertically movable lift arm support 104. A threaded drive shaft 117 extends from the lift arm drive motor 116. A half-moon driven plate 118 is attached to the pivotable lift arm base 106 of the pivotable lift arm 105. Also as shown, a two-direction lift arm drive motor 118 is also fixed to the vertically movable lift arm support 104. A threaded drive shaft 119 extends from the lift arm drive motor 118. A half-moon driven plate 120 is attached to the pivotable lift arm base 111 of the pivotable lift arm 110.

In operation, the two-direction lift arm drive motors 116 and 118 operate in one direction to rotatably position the pivotable lift arms 105 and 110 respectively until the lift pads are in their desired positions for lifting the vehicle and in a reverse direction to move the pivotable lift arms 105 and 110 from under the vehicle to their stowed positions.

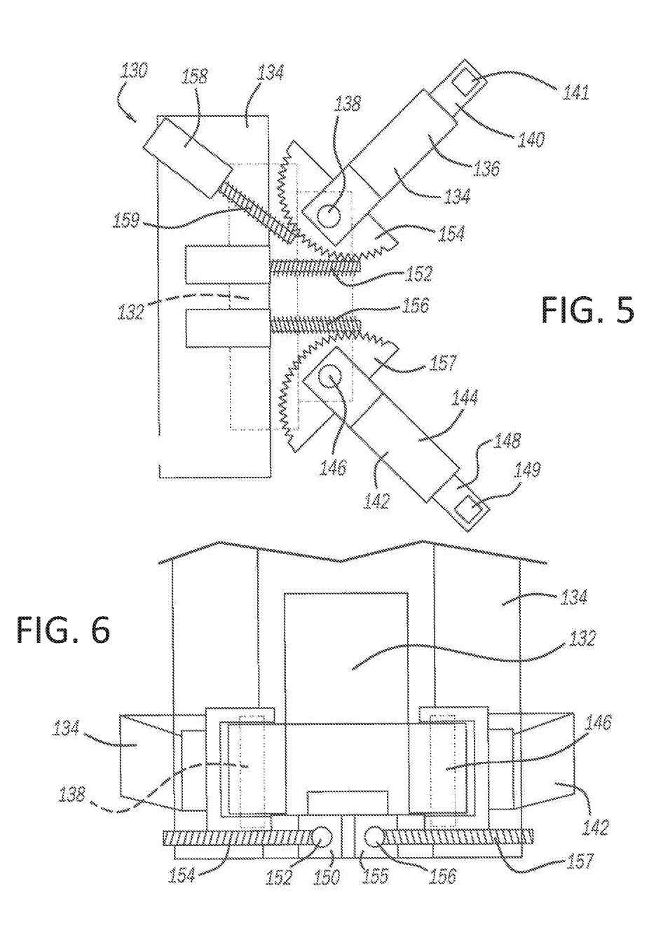

Referring to FIGS. 5 and 6, a views of a lift arm assembly according to a further embodiment of the disclosed inventive concept is illustrated, generally shown as 130. FIG. 5 illustrates a top view of the lift arm assembly 130 attached to a lift post. FIG. 6 illustrates a back view of the lift arm assembly 130 attached to a lift post.

The lift arm assembly 130 includes a vertically movable lift arm support 132 movably attached to a vertical post of either the above-ground fixed type as shown in FIG. 1 or of the in-ground type shown in FIG. 2. Pivotably attached to the vertically movable lift arm support 132 is a first pivotable lift arm 134 that has a pivotable lift arm base 136. The pivotable lift arm base 136 is pivotably attached to the movable lift arm support 132 by a pivot 138. A pivotable lift arm telescoping extension 140 is telescopingly attached to the pivotable lift arm base 136. A lifting pad 141 is attached to one end of the pivotable lift arm telescoping extension 140.

The lift arm assembly 130 further includes a second pivotable lift arm 142 that is pivotably attached to the vertically movable lift arm support 132. The pivotable lift arm 142 has a pivotable lift arm base 144. The pivotable lift arm base 144 is pivotably attached to the vertically movable lift arm support 132 by a pivot 146. A pivotable lift arm telescoping extension 148 is telescopingly attached to the pivotable lift arm base 144. A lifting pad 149 is attached to one end of the pivotable lift arm telescoping extension 148.

In a way similar to the method of positioning the pivotable lift arms 105 and 110 relative to the vertically movable lift arm support 104 of the embodiment of the lift assembly shown in FIG. 4, the lift assembly 130 illustrated in FIGS. 5 and 6 may be adjusted by any of several arrangements, including but not limited to a hydraulic system or a mechanical screw system. A suggested geared arrangement is illustrated in FIGS. 5 and 6. Referring to these figures, a two-direction lift arm drive motor 150 is fixed to the vertically movable lift arm support 132. A threaded drive shaft 152 extends from the lift arm drive motor 150. A half-moon driven plate 154 is attached to the pivotable lift arm base 136 of the pivotable lift arm 134. Also as shown, a two-direction lift arm drive motor 155 is also fixed to the vertically movable lift arm support 132. A threaded drive shaft 156 extends from the lift arm drive motor 155. A half-moon driven plate 157 is attached to the pivotable lift arm base 142 of the pivotable lift arm 144. (As a possible alternative placement of the drive motor relative to the vertically movable lift arm support 132, a drive motor 158 having a threaded drive shaft 159 is placed in an alternative position relative to the vertically movable lift arm support 132.)

In operation, the two-direction lift arm drive motors 150 and 155 operate in one direction to rotatably position the pivotable lift arms 134 and 142 respectively until the lift pads are in their desired positions for lifting the vehicle and in a reverse direction to move the pivotable lift arms 134 and 142 from under the vehicle to their stowed positions.

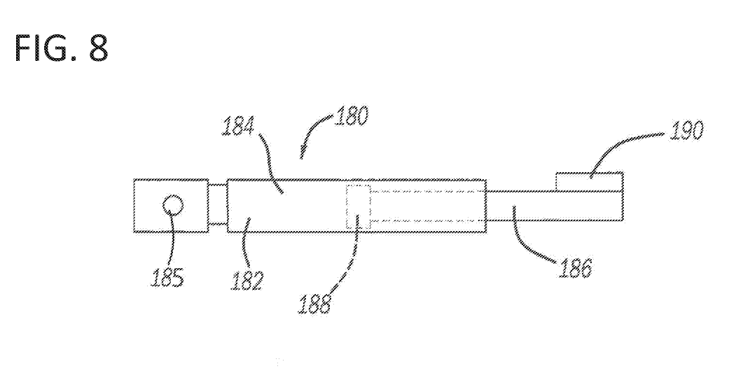

The telescoping arms of the disclosed inventive concept may be of a variety of constructions. Two possible constructions are illustrated in FIGS. 7 and 8, neither of which is intended as being limiting.

One of the disclosed embodiments for the telescoping lift arm is illustrated in FIG. 7 in which an embodiment of a telescoping lift arm is shown and is generally illustrated as 160. The telescoping lift arm 160 includes a pivotable base section 162, a first telescoping segment 164 that is telescopingly positionable within the first pivotable base section 162, and a second telescoping segment 166 that is telescopingly positionable within the first telescoping segment 164. A greater or lesser number of telescoping segments may be telescopingly attached to the pivotable base section 162. A lift pad 168 is attached to the second telescoping segment 166 by a scissors lift 170.

The first telescoping segment 164 and the second telescoping segment 166 are driven between their extended positions (as illustrated in FIG. 7) and their retracted positions (not shown) by gearing such as worm gears, spider gears, or a rack-and-pinion arrangement that includes gears 172 and 172′. The gears 172 and 172′ are driven one or more electric motors (not illustrated) that are connected to a power source by a line 176. Alternatively, the gearing may be hydraulically driven and, accordingly, the line 176 may be a hydraulic line.

An alternative construction of the telescoping arms of the disclosed inventive concept is illustrated in FIG. 8 in which a side view of a telescoping lift arm, generally illustrated as 180, is illustrated. The telescoping lift arm 180 includes a pivotable base section 182, a piston sleeve 184, and a movable arm 186 that is telescopingly positionable within the piston sleeve 184. The pivotable base section 182 is attached to a lift post (not shown) by a lift arm pivot pin 185. The movable arm 186 is driven pneumatically, hydraulically or electrically. For example, a driving member such as a piston 188 (shown in broken lines) may be reciprocatingly positioned within the piston sleeve 184. Alternatively, the driving member may be a screw mechanism.

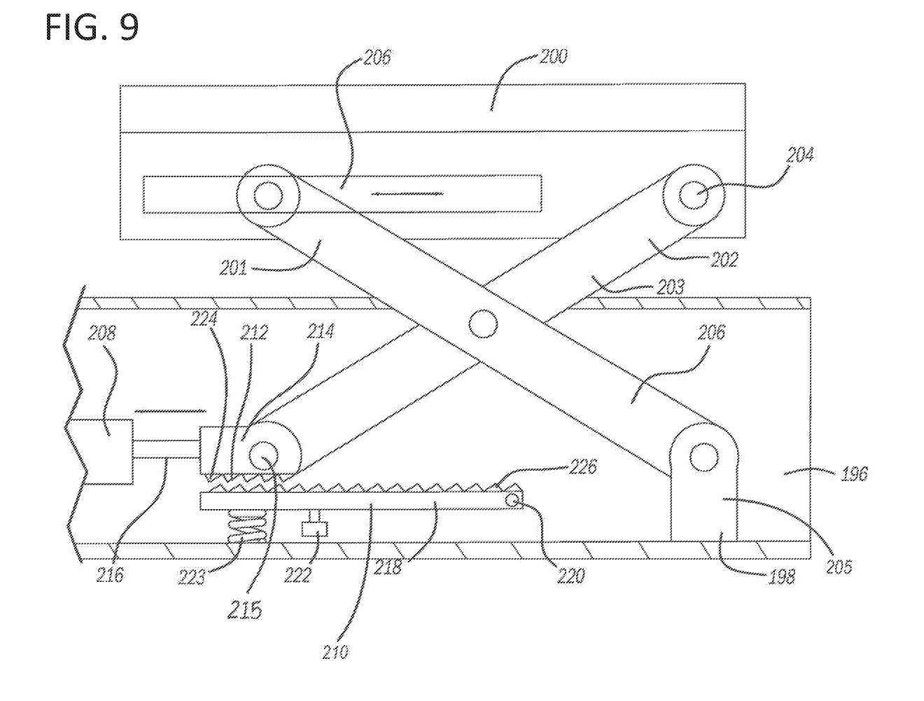

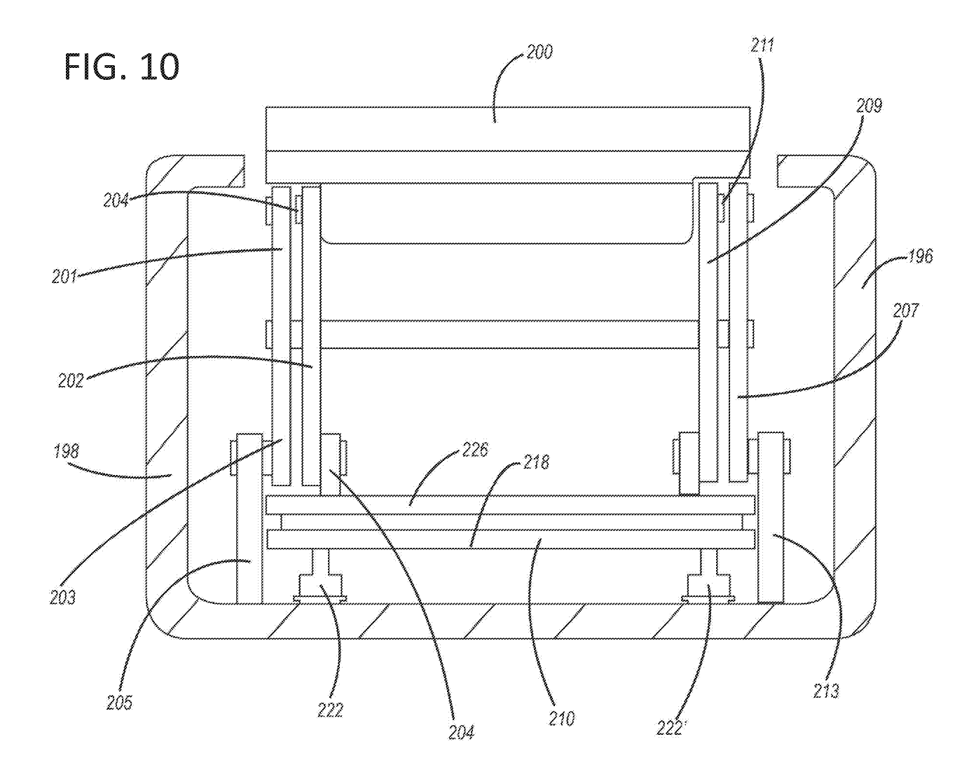

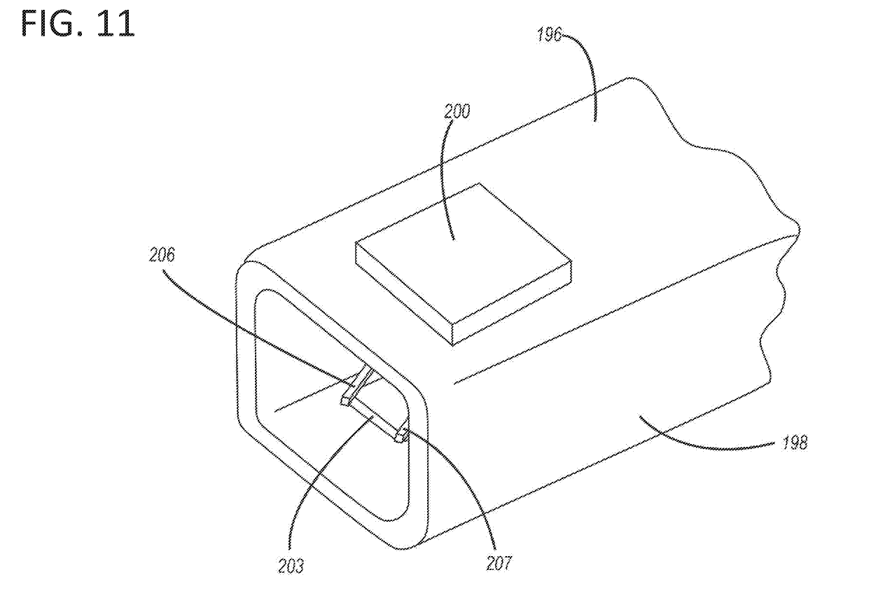

The lift pads of the disclosed inventive concept may also be of a variety of constructions. A suggested but not exclusive embodiment is illustrated in FIGS. 9, 10 and 11 in which a lift pad assembly 196 is shown in a side view, an end view, and a perspective view respectively. The lift pad assembly 196 includes a movable arm 198 to which a lift pad 200 is attached by a lifting arrangement such as a first pair of interconnected scissors arms 201 and 202 on one side and a second pair of interconnected scissors arms 207 and 209 on the other side (shown in FIG. 10) which define a scissors lift 203.

One end of the scissors arm 202 is rotatably mounted on a stationary pin 204 that is attached to the lift pad 200. One end of the scissors arm 201 is rotatably mounted on a support bracket 205 that is fixed to the movable arm 198. The other end of the scissors arm 201 is movably attached to a slot 206 formed in the lift pad 200. As illustrated in FIG. 10, one end of the scissors arm 209 is rotatably mounted on a stationary pin 211 that is attached to the lift pad 200. One end of the scissors arm 207 is rotatably mounted on a support bracket 213 that is fixed to the movable arm 198. The other end of the scissors arm 207 is movably attached to a slot (not shown) formed in the lift pad 200. Alternative lifting mechanisms such as a screw or pneumatic lift may be incorporated into the lift pad assembly 196 instead of the scissors lift 203.

A driver 208 is connected to the scissors lift 203. The driver 208 may be pneumatic or may alternatively be a screw mechanism.

The lift pad assembly 196 further includes a locking arrangement to hold the lift pad 200 in its raised position as illustrated. The locking arrangement may be any of a mechanical, pneumatic, electric, electromagnetic, or hydraulic arrangement. One such arrangement is illustrated in FIGS. 9 and 10 in which a locking system 210 is provided and is attached to the movable arm 198. The locking system 210 includes a locking foot 212 formed on the underside of a locking foot support 214. The locking foot support 214 is pivotably attached to the scissors arm 202 by a pivot pin 215.

A reciprocating shaft 216 extends from the driver 208 and is connected to the locking foot support 214. A pivotable locking plate 218 is attached to the movable arm 198 by a pivot 220. At the end of the pivotable locking plate 218 opposite the pivot 220 is a locking plate actuators 222 and 222′ and a spring 223. The spring holds tension of the pivotable locking plate 218 against the locking foot 212 when the locking plate actuators 222 and 222′ do not draw down the pivotable locking plate 218 away from the locking foot 212 as described below.

In operation, the pivotable locking plate 218 is first moved into engagement with the locking foot 212 by the locking plate actuators 222 and 222′. The movable arm 198 is thereafter moved so that the lift pad 200 is correctly positioned under the vehicle. The driver 208 is then engaged causing the reciprocating shaft 216 to extend outward and thereby pushing against the locking foot support 214. A scissoring action of the interconnected scissors arms 201 and 202 and the interconnected scissors arms 207 and 209 of the scissors lift 203 occurs, thereby driving the lift pad 200 upward and into contact with the vehicle's underside. As illustrated, the locking foot 212 includes teeth 224 and the pivotable locking plate 218 includes teeth 226.

The teeth 224 are angled in a direction opposite that of the teeth 226. Because of these angles, the teeth 224 and the teeth 226 can slide over one another when the locking foot 212 moves against the pivotable locking plate 218 when the lift pad 200 is being scissored to its raised position as shown. These same angles allow the teeth 224 to engage the teeth 226 to thereby resist movement of the locking foot 212 in a direction back toward the driver 208. Only when the locking plate actuators 222 and 222′ move the pivotable locking plate 218 downward and out of engagement with the locking foot 212 can the locking foot 212 be allowed to move toward the driver 208, thus allowing the lift pad 200 to be lowered out of engagement with the vehicle's underside.

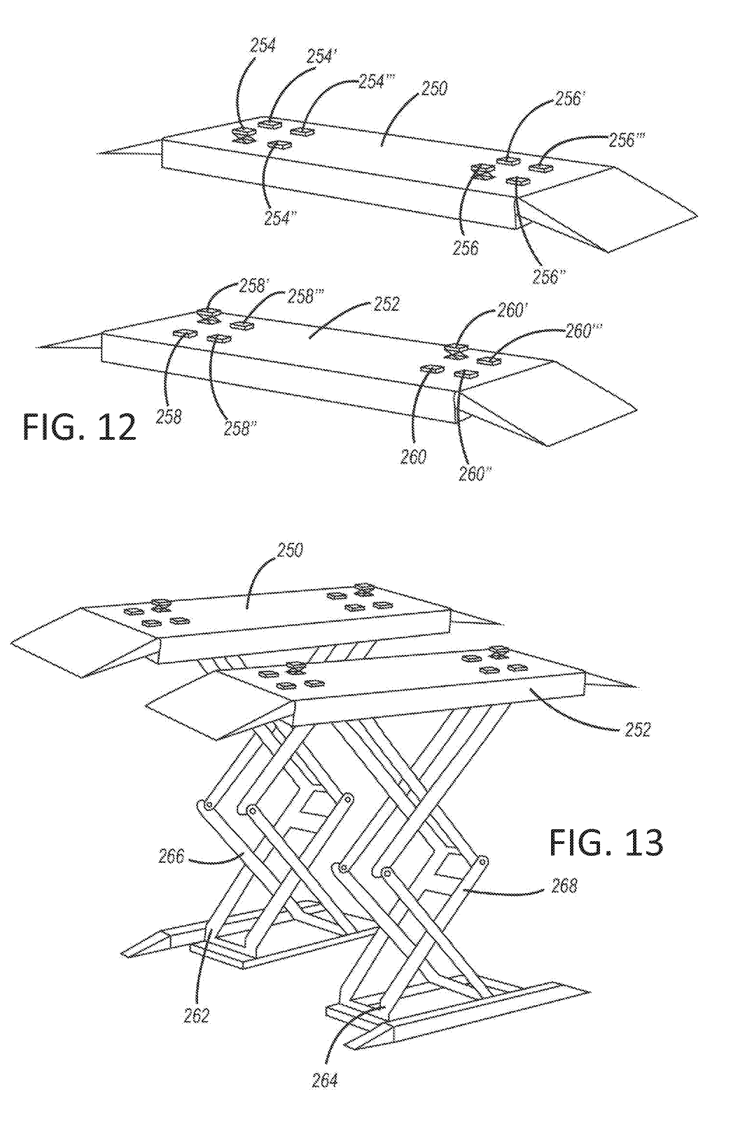

The disclosed inventive concept of a fully autonomous vehicle lift has variations beyond those discussed above and disclosed in FIGS. 1 through 11. An additional embodiment of the disclosed inventive concept is illustrated in FIGS. 12 and 13. Referring to FIG. 12, a perspective view of a pair of lift ramps is illustrated and includes a first lift ramp 250 and a second lift ramp 252. The lift ramps 250 and 252 are positioned on the tops of lifting assemblies such as the scissors lifts of FIG. 13. It is to be understood that while scissors lifts are illustrated, alternative arrangements for lifting the lift ramps 250 and 252 may be adopted for use, such as dual or single posts.

As an alternative to movable lift arms having movable lift pads discussed above, each of the lift ramps 250 and 252 is fitted with a plurality of independently movable lift pads. Referring to the lift ramp 250, a first set of lift pads 254, 254′, 254″ and 254″ and a second set of lift pads 256, 256′, 256″ and 256″ are provided. Referring to the lift ramp 252, a first set of lift pads 258, 258′, 258″ and 258″ and a second set of lift pads 260, 260′, 260″ and 260′″ are provided. Each of the lift pads may be lifted independently as needed to safely and properly be positioned under the vehicle to be lifted. As illustrated in FIG. 12, the lift pads 245, 256, 258′ and 260′ are shown as having been lifted.

As noted, each of the lift ramps 250 and 252 may be raised from the garage floor by a number of methods, including a lifting post or, as illustrated in FIG. 13, by scissors lifts. Referring to FIG. 13, a first scissors lift 262 is operatively associated with the first lift ramp 250 and a second scissors lift 264 is operatively associated with the second lift ramp 252. The first scissors lift 262 includes a plurality of scissor arms 266 and the second scissors lift 264 includes a plurality of scissor arms 268.

The step-wise operation of the disclosed inventive concept includes the following steps. The vehicle is first is moved into position relative to the autonomous vehicle lift system. At this step one or both of the vehicle's front wheels are positioned onto a front wheel locator. Then the operator enters the vehicle's identification information into an operator's station either manually using a keyboard or using a scanner suited for this purpose. As soon as the vehicle's identification information is entered and confirmed, the autonomous lift arm placement will initiate. Once initiated, the arms will pivot under the vehicle and will extend or retract as needed to the proper location. Once the arms are in their proper position, the lift pads extend upward.

With the lift arms and the lift pads in position, the operator presses the “UP” button on the operator's station and holds the button down until the vehicle is lifted to its desired height for servicing. No further action is required on the part of the operator until the vehicle service is complete.

Once vehicle service is complete, the operator presses and holds the “DOWN” button until the lift is in its fully lowered position. Automatically, the lift pads lower, the lift arms retract and the lift arms pivot from underneath the vehicle. The vehicle can then be driven out of the service bay. The lift is ready for the next vehicle.

One skilled in the art will readily recognize from such discussion, and from the accompanying drawings and claims that various changes, modifications and variations can be made therein without departing from the true spirit and fair scope of the invention as defined by the following claims. As a non-limiting example of a possible modification, a gauge or stop that enables the operator to know how many ribs or material are to be removed could readily be provided to the belt cutter as described and as illustrated in the accompanying figures.

What is claimed is:

1. An autonomous vehicle lift system comprising:
a lifting post;
a vertically movable lift arm assembly attached to said post, said assembly including a pivotable lift arm, said arm having a lift pad;
an operator's station for inputting vehicle identification and for initiating the lifting operation; and
an interface between said assembly and said station wherein said arm and said pad are moved into position without operator involvement once the lifting operation is initiated.

2. The autonomous vehicle lift system of claim 1, wherein said lift pad includes a lifting mechanism for lifting said pad from said lift arm.

3. The autonomous vehicle lift system of claim 2, wherein said lifting mechanism is a scissors mechanism.

4. The autonomous vehicle lift system of claim 1, wherein said lifting post comprises a pair of spaced apart and opposed posts.

5. The autonomous vehicle lift system of claim 1, wherein said vertically movable lift arm assembly includes two autonomous and independently operable pivotable lift arms.

6. The autonomous vehicle lift system of claim 1, wherein said operator's station includes a scanner for reading the vehicle identification number of the vehicle to be lifted.

7. The autonomous vehicle lift system of claim 1, further including at least one wheel locator.

8. The autonomous vehicle lift system of claim 1, wherein said arm includes at least two segments of which one can telescope into the other.

9. The autonomous vehicle lift system of claim 8, wherein one of said segments is moved by a driver, said driver being selected from the group consisting of an electric motor having gearing and a pneumatic cylinder.

10. An autonomous vehicle lift system comprising:
a lifting post;
a vertically movable lift arm assembly attached to said post, said assembly including a pair of lift arms, each arm having a lift pad;
a vehicle identification input;
a system initiator; and
an interface between said assembly and said input wherein said arms and said pads are moved into position without operator involvement once the lifting operation is initiated.

11. The autonomous vehicle lift system of claim 10, wherein each of said pads includes a lifting mechanism for lifting said pad from said lift arm.

12. The autonomous vehicle lift system of claim 11, wherein said lifting mechanism is a scissors mechanism.

13. The autonomous vehicle lift system of claim 10, wherein said lifting post comprises a pair of spaced apart and opposed posts.

14. The autonomous vehicle lift system of claim 10, wherein said lift arm assembly includes a lift arm support and said lift arms are pivotably attached to said support.

15. The autonomous vehicle lift system of claim 10, wherein further including an operator's station, said station including said vehicle identification input and said system initiator.

16. The autonomous vehicle lift system of claim 15, wherein said vehicle identification input is a scanner.

17. The autonomous vehicle lift system of claim 10, further including at least one wheel locator.

18. The autonomous vehicle lift system of claim 10, wherein each of said arms includes at least two segments of which one can telescope into the other.

19. The autonomous vehicle lift system of claim 18, wherein at least one of said segments is moved by a driver, said driver being selected from the group consisting of an electric motor having gearing and a pneumatic cylinder.

20. A method for autonomously lifting a vehicle, the method comprising:
forming an autonomous lift system comprising a lifting post, a vertically movable lift arm assembly attached to said post, said assembly including a pivotable lift arm, said arm having a lift pad, an operator's station for inputting vehicle identification and for initiating the lifting operation, and an interface between said assembly and said station;
moving the vehicle to be lifted into position relative to the system;
inputting the vehicle identification into said station;
initiating the lifting operation, after which point the operations of moving said arm and said pad into position beneath the vehicle and the lifting of the vehicle occur automatically and without operator involvement once the lifting operation is initiated.
